(19) United States
(12) Patent Application Publication
(10) Pub. No.: US 2026/0131737 A1
(43) Pub. Date: May 14, 2026

(54) COVERING SHELF APPARATUS FOR VEHICLE

(71) Applicants: Hyundai Motor Company, Seoul (KR); Kia Corporation, Seoul (KR)

(72) Inventors: Yeong Rae JO, Hwaseong-Si (KR); Jong Tae LEE, Hwaseong-Si (KR); Dae Min LEE, Hwaseong-Si (KR)

(21) Appl. No.: 19/202,684

(22) Filed: May 8, 2025

(30) Foreign Application Priority Data
Nov. 13, 2024 (KR) 10-2024-0161183

(51) Int. Cl. B60R 5/04

(52) U.S. Cl. CPC B60R 5/045

(57) ABSTRACT

A covering shelf apparatus for a vehicle may include a front end portion and a rear end portion configured to be folded and stacked in multiple layers, where the front end portion is configured to be rotated and folded downward relative to the rear end portion, such that a reclining operation of a rear seat is allowable, thereby improving ride quality and marketability.

### CROSS-REFERENCE TO RELATED APPLICATION

The present application claims priority to Korean Patent Application No. 10-2024-0161183, filed on Nov. 13, 2024, the entire contents of which are incorporated herein for all purposes by this reference.

### TECHNICAL FIELD

The present disclosure relates to a covering shelf apparatus for a vehicle, and more particularly, to a technology related to a covering shelf apparatus for a vehicle, the covering shelf apparatus being capable of coping with a reclining operation of a rear seat and being used and stored in a collapsible manner.

### BACKGROUND

A vehicle may have a space (e.g., for a luggage room) between a rear (e.g., second-row or third row, etc.) seat and a tail gate. The vehicle may be equipped with a covering shelf configured to shield the space.

In a state in which the covering shelf is installed, a reclining operation of a seatback of the rear seat typically cannot be performed. In this case, a passenger may feel discomfort.

The foregoing explained as the background is intended merely to aid in the understanding of the background of the present disclosure, and is not intended to mean that the present disclosure falls within the purview of the related art that is already known to those skilled in the art.

### SUMMARY OF THE DISCLOSURE

The following summary presents a simplified summary of certain features. The summary is not an extensive overview and is not intended to identify key or critical elements.

Systems, apparatuses, and methods are described for a covering shelf apparatus for vehicle. A covering shelf apparatus for a vehicle may comprise: a covering shelf configured to be folded and stacked in multiple layers; and a pair of hinges each coupled to one of two opposite sides of a front end portion of the covering shelf, wherein each of mounting rods of the pair or hinges is configured to move forward or rearward relative to a corresponding hinge of the pair of hinges, wherein the front end portion is configured to be rotated and folded downward based on the front end portion being pressed by a seatback of a rear seat of the vehicle being reclined.

Also, or alternatively, a vehicle may comprise: a rear seat configured to recline backward; a luggage room, rear to the rear seat, comprising: a first luggage side trim forming a first guide groove; and a second luggage side trim forming a second guide groove; and a covering shelf comprising: a first hinge coupled to a first side of a front end portion of the covering shelf; a second hinge coupled to a second side of the front end portion of the covering shelf; a first mounting rod configured to move forward or rearward relative to the first hinge; and a second mounting rod configured to move forward or rearward relative to the second hinge, wherein the first and second guide grooves are configured to guide movements of the first and second mounting rods based on reclining of the rear seat or reversal of reclining of the rear seat.

These and other features and advantages are described in greater detail below.

### BRIEF DESCRIPTION OF THE DRAWINGS

FIG. 1 is a view illustrating a state in which a front end portion and a rear end portion of a covering shelf according to the present disclosure is folded and installed in a forward/rearward direction.

FIG. 2 is a view illustrating a state in which the front end portion of the covering shelf is rotated and folded downward by a reclining operation of a rear seat.

FIG. 3 is a view illustrating a state in which the rear end portion of the covering shelf is folded and stacked in three layers.

FIG. 4 is a view illustrating a state in which the covering shelf, which is folded in multiple layers, is accommodated in an accommodation space of a luggage board.

FIG. 5 is a view illustrating a state in which the covering shelf according to the present disclosure is unfolded.

FIG. 6 is an enlarged view of a portion to which a hinge unit in FIG. 5 is coupled.

FIG. 7, FIG. 8, and FIG. 9 are views illustrating states made before a rear seat is reclined by the hinge unit according to the present disclosure.

FIG. 10 and FIG. 11 are views illustrating states in which the hinge unit is completely operated by the reclining operation of the rear seat.

FIG. 12 is a view for explaining a guide groove according to the present disclosure.

FIG. 13 is a view illustrating a state made before the reclining operation of the rear seat is performed and the front end portion and rear end portion of the covering shelf are unfolded on a plane.

FIG. 14 is an enlarged view of FIG. 13.

FIG. 15 is a view illustrating a state in which the reclining operation of the rear seat is completed and the front end portion of the covering shelf is rotated downward and folded.

### DETAILED DESCRIPTION

In the description of examples disclosed in the present specification, the specific descriptions of publicly known related technologies will be omitted if it is determined that the specific descriptions may obscure the subject matter of the examples disclosed in the present specification. In addition, the accompanying drawings are provided only to allow those skilled in the art to easily understand the examples disclosed in the present specification, and the technical spirit disclosed in the present specification is not limited by the accompanying drawings, and includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms. These terms are used only to distinguish one constituent element from another constituent element.

Singular expressions include plural expressions unless clearly described as different meanings in the context.

In the present specification, it should be understood the terms “comprises,” “comprising,” “includes,” “including,” “containing,” “has,” “having” or other variations thereof are inclusive and therefore specify the presence of stated features, integers, steps, operations, elements, components, or combinations thereof, but do not preclude the presence or addition of one or more other features, integers, steps, operations, elements, components, or combinations thereof.

The suffixes “module”, “unit”, “part”, and “portion” used to describe constituent elements in the following description are used together or interchangeably in order to facilitate the description, but the suffixes themselves do not have distinguishable meanings or functions.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements.

In addition, the term “control unit” or “unit” included in the name of “motor control unit (MCU)” or “hybrid control unit (HCU)” is merely a term widely used to name a control device (e.g., interchangeably a controller or control unit herein) for controlling a particular vehicle function but does not mean a generic function unit.

A controller may include a communication device configured to communicate with another control unit and/or a sensor to control a corresponding function, a memory configured to store an operating system, a logic instruction, and/or input/output information, and one or more processors configured to run the operating system and/or execute the logic instruction so as to perform determination, computation, decision, or the like required to control a corresponding function.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Hereinafter, examples disclosed in the present specification will be described in detail with reference to the accompanying drawings. The same or similar constituent elements are assigned with the same reference numerals regardless of reference numerals, and the repetitive description thereof will be omitted.

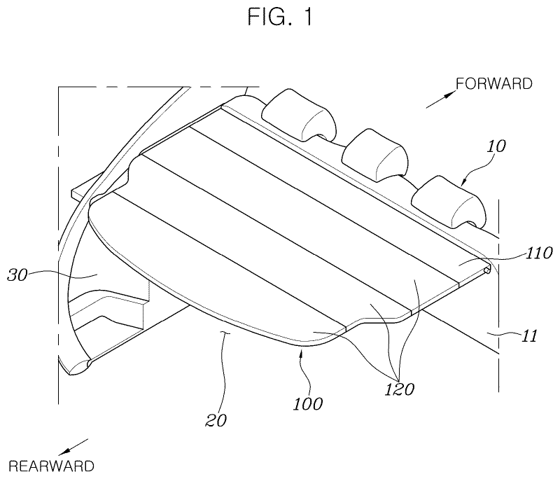

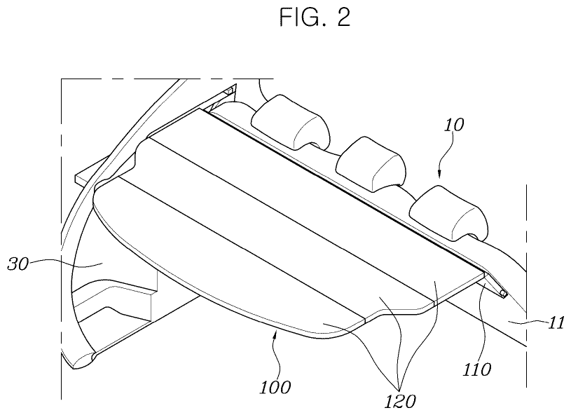

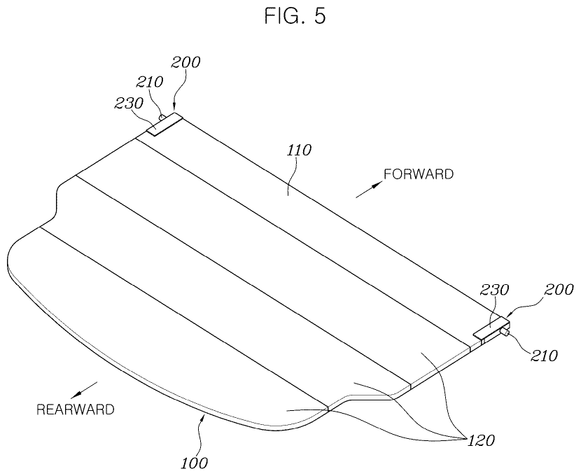

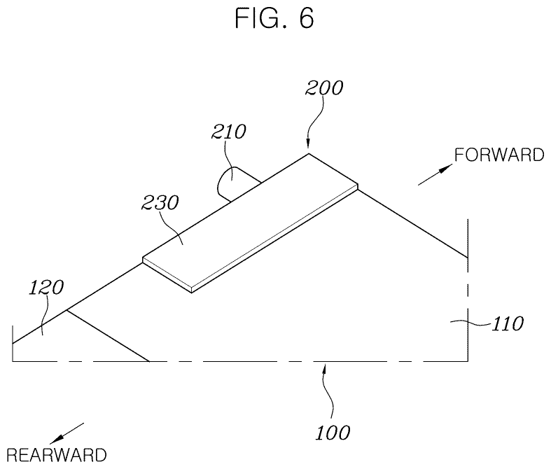

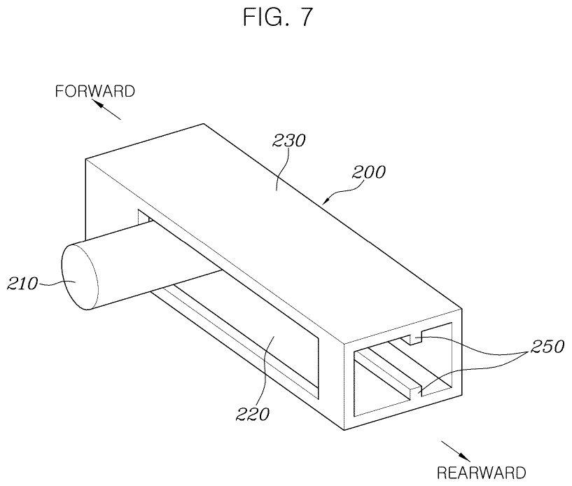

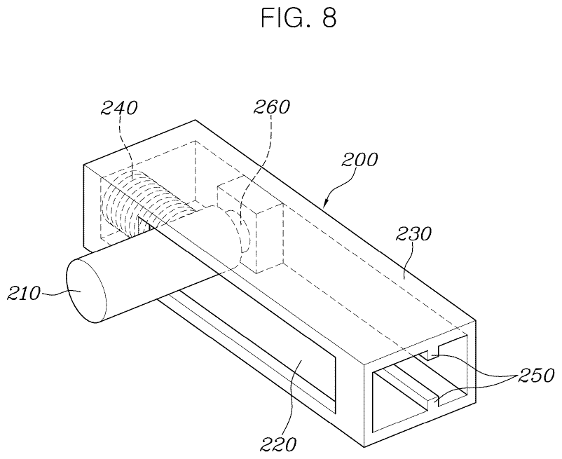

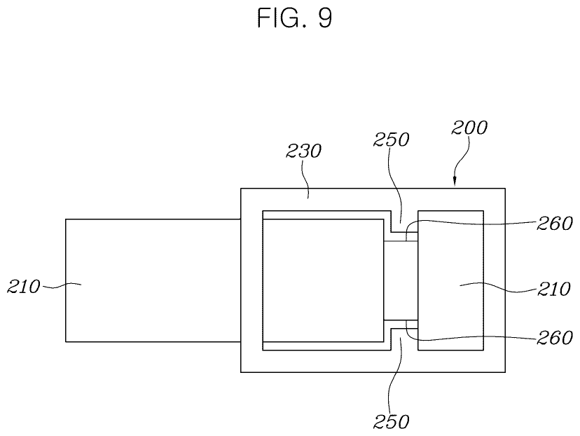

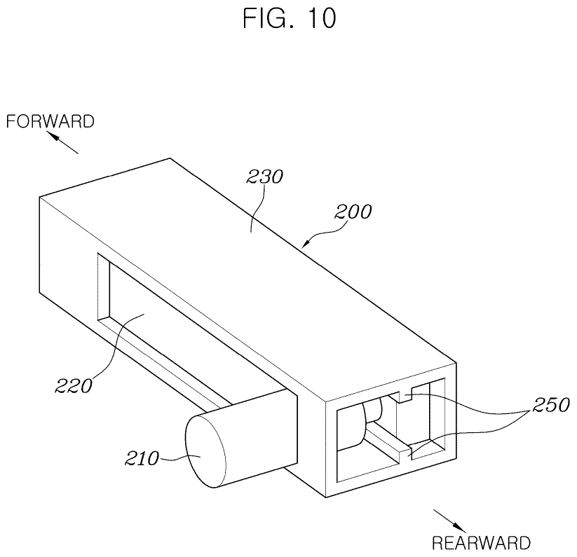

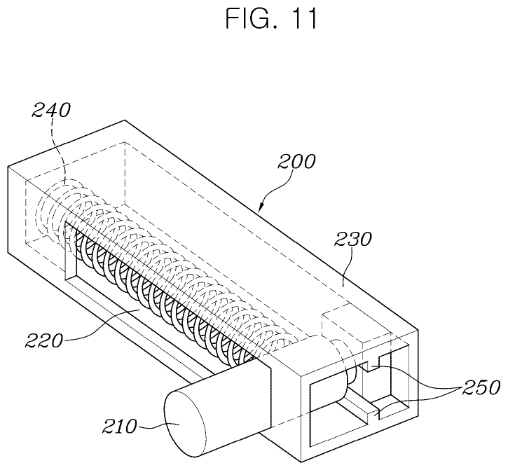

A covering shelf apparatus for a vehicle according to the present disclosure may include a covering shelf 100 structured to be folded and stacked in multiple layers (e.g., as in FIGS. 1-4), and hinge units 200 (e.g., hinges) coupled to two opposite left and right sides of a front end portion of the covering shelf 100 and having mounting rods 210 configured to move forward or rearward (e.g., as in FIGS. 5-11). The hinge units 200 may be coupled to a front end portion 110 of the covering shelf 100, where “front” refers to a frontward direction relative to a front of the vehicle (e.g., and end portion towards the rear seats relative to the tailgate of the vehicle, when the covering shelf 100 is installed in the vehicle). The front end portion 110 may be configured to allow a reclining operation of a seatback 11 of a rear seat 10 while being rotated and folded downward by being pressed by the seatback 11 when the reclining operation of rotating the seatback 11 rearward is performed (e.g., FIG. 2).

The covering shelf 100 according to the present disclosure may include a front end portion 110 to which the hinge units 200 are coupled, and a rear end portion 120 extending rearward from the front end portion 110 (e.g., toward the tailgate from the rear seat). The rear end portion 120 may have a longer length in a forward/rearward direction than the front end portion 110.

The front end portion 110 and the rear end portion 120 of the covering shelf 100 may be able to rotate relative to each other (e.g., so as to be structured to be folded). The rear end portion 120 may be structured to be further folded and/or stacked at least in three or more layers.

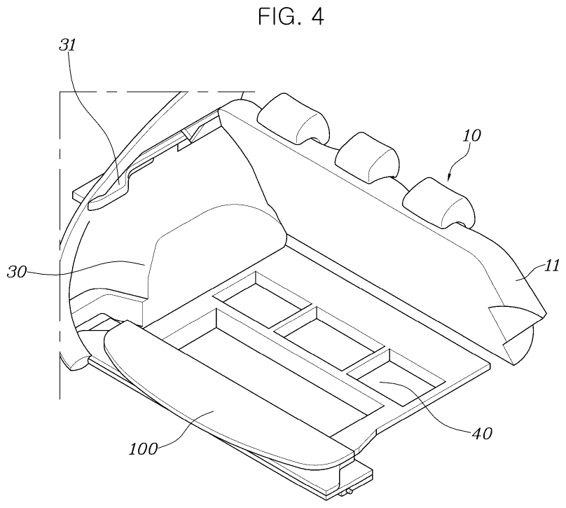

The covering shelf 100 according to the present disclosure may be structured to be folded and stacked in multiple layers, such that the covering shelf 100 may be conveniently used and stored when not in use (e.g., FIG. 4).

FIG. 1 illustrates a state in which the front end portion 110 and the rear end portion 120 of the covering shelf 100 are fully unfolded in the forward/rearward direction and installed on a plane. In this case, a space of a luggage room 20 is shielded by the covering shelf 100.

FIG. 2 illustrates a situation in which the reclining operation of rotating rearward the seatback 11 of the rear seat 10. In this case, the front end portion 110 of the covering shelf 100 is rotated and folded downward relative to the rear end portion 120 of the covering shelf 100. According to the example, the reclining operation of the rear seat 10 is allowable by the rotation of the front end portion 110 of the covering shelf 100, thereby improving the ride quality while using the covering shelf 100 and marketability.

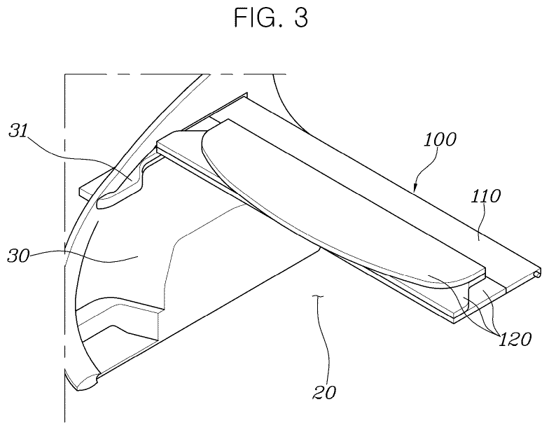

FIG. 3 illustrates a state in which the front end portion 110 of the covering shelf 100 is unfolded forward from the rear end portion 120, and the rear end portion 120 is folded and stacked in three layers. In this case, a part of the space of the luggage room 20 may be made accessible/exposed to the outside through the folded rear end portion 120.

FIG. 4 illustrates a state in which both the front end portion 110 and the rear end portion 120 of the covering shelf 100 are folded and stacked in multiple layers. The covering shelf 100, which is folded in multiple layers as described above, may be separated from a luggage side trim 30 and then accommodated and stored in an accommodation space of a luggage board 40, such that the covering shelf 100 may have a compact size and be conveniently stored when not in use.

Guide grooves 300 may be formed in the luggage side trim 30. Mounting rods 210 of the hinge unit 200 may be configured to be inserted into the guide grooves 300. The guide grooves 300 may guide movements of the mounting rods 210 when the front end portion 110 of the covering shelf 100, to which the hinge units 200 are coupled, is rotated and folded downward by the reclining operation of the rear seat 10, or rotated and unfolded upward by reversal of the reclining operation of the rear seat 10.

The guide grooves 300 may be provided at positions on the luggage side trim 30 that face the hinge units 200 coupled to the left and right sides of the front end portion 110 of the covering shelf 100.

The front end portion 110 of the covering shelf 100 may be installed such that the mounting rods 210 of the hinge units 200 are inserted into the guide grooves 300 formed in the luggage side trim 30. The rear end portion 120 of the covering shelf 100 may be installed such that two opposite left and right sides thereof are seated on protrusion portions 31 (e.g., protrusions) protruding from the luggage side trim 30.

According to the present disclosure, the two opposite left and right sides of the rear end portion 120 of the covering shelf 100 may be installed and seated on the protrusion portions 31 of the luggage side trim 30. The front end portion 110 of the covering shelf 100 may be installed regardless of the protrusion portions 31 (e.g., without corresponding protrusion portions and/or without the protrusion portions 31 extending to the front end portion 110), such that a length of the protrusion portion 31 in the forward/rearward direction may be reduced.

Also, or alternatively, the front end portion 110 of the covering shelf 100 may be installed by the mounting rods 210 of the hinge units 200 and the guide grooves 300 formed in the luggage side trim 30, such that the front end portion 110 of the covering shelf 100 may allow the reclining operation of the rear seat 10, even when the covering shelf 100 is in use/employed.

As illustrated in FIG. 1, the covering shelf 100 may be in a state in which the front end portion 110 and the rear end portion 120 of the covering shelf 100 are unfolded and on a plane relative to each other and the mounting rods 210 of the hinge units 200 may be inserted into the guide grooves 300 formed in the luggage side trim 30. If a user holds a rear end portion 120 of the covering shelf 100 and moves the covering shelf 100 upward, the covering shelf 100 may move upward by rotating about the mounting rods 210 inserted into the guide grooves 300. In this case, the mounting rods 210 inserted into the guide grooves 300 serve as rotation centers.

The hinge units 200 according to the present disclosure may further include hinge housings 230 fixedly coupled to the two opposite left and right sides of the front end portion 110 of the covering shelf 100. The hinge housings 230 may have slit holes 220 extending in the forward/rearward direction (e.g., in a longitudinal direction of the hinge housings 230).

The mounting rod 210 of the hinge unit 200 may penetrate the slit hole 220. The mounting rod 210 may be installed to be movable forward and/or rearward along the slit hole 220, for example, based on an external force being applied. A first end portion (e.g., a first end) of the mounting rod 210 may be positioned in the hinge housing 230, and a second end portion (e.g., a second end) of the mounting rod 210 may protrude to outside of the hinge housing 230 and may be inserted into the guide groove 300.

As the mounting rod 210 moves along the slit hole 220, the second end portion of the mounting rod 210 may move along the guide groove 300.

The hinge unit 200, according to the present disclosure, may further include a restoring spring 240 having two opposite ends coupled to the mounting rod 210 and the hinge housing 230, respectively. The restoring spring 240 may accumulate/generate a spring force while being extended when the mounting rod 210 moves rearward (e.g., by an operating force), and the restoring spring 240 may return the mounting rod 210 forward by generated the spring force (e.g., when the operating force is removed).

The restoring spring 240 may be configured as a tensile spring. However, the present disclosure is not limited thereto.

Guide protrusions 250 may be formed on the hinge housing 230. The guide protrusions may extend in a movement direction of the mounting rod 210 and protrude inward from an inner surface of the hinge housing 230. Insertion grooves 260 may be formed in the mounting rod 210. The guide protrusions 250 may be inserted into the insertion grooves 260. The forward/rearward movement of the mounting rod 210 may be guided by the guide protrusions 250 and the insertion grooves 260.

According to the present disclosure, the guide groove 300 formed in the luggage side trim 30 may include a first groove 310 formed to be inclined downward and rearward from the front side. The guide groove 300 may be configured to guide the movement of the mounting rod 210 when the front end portion 110 of the covering shelf 100 is rotated and folded downward by the reclining operation of the rear seat 10 or rotated and folded upward by reversal of reclining operation of the rear seat 10. The guide groove 300 may further include a second groove 320 connected to a rear end portion of the first groove 310 and formed to be inclined upward and rearward.

A rear end portion of the first groove 310 and a front end portion of the second groove 320 may be connected to/continuous with each other, such that an overall shape of the guide groove 300 may be a ‘V’ shape. However, the present disclosure is not limited thereto.

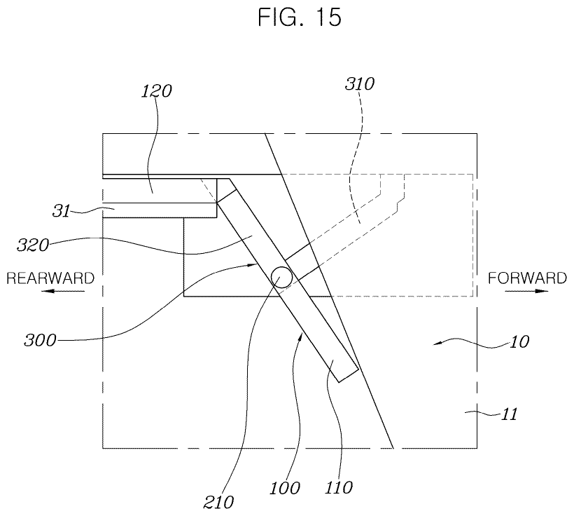

With reference to FIG. 15, the mounting rod 210 may be positioned at a connection point between the first groove 310 and the second groove 320 due to the front end portion 110 of the covering shelf 100 being rotated and folded downward, such that the two opposite sides of the front end portion 110 of the covering shelf 100 may be positioned in the second grooves 320.

A front end portion of the first groove 310 may be opened upward, such that the mounting rod 210 may be inserted into the first groove 310 or the mounting rod 210 may be separated from the first groove 310.

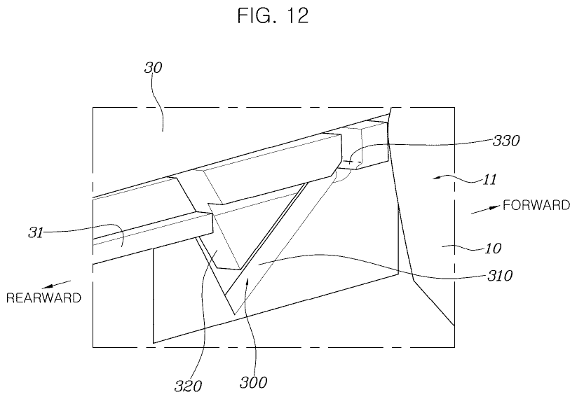

With reference to FIGS. 12 to 14, a catching projection 330 may be provided at the front end portion of the first groove 310. The catching projection 330 may protrude from the inside of the first groove 310. If the mounting rod 210 is inserted through the opened front end portion of the first groove 310, the mounting rod 210 may be caught by the catching projection 330 and seated. If the mounting rod 210 is caught by the catching projection 330 and seated, the front end portion 110 of the covering shelf 100 and the rear end portion 120 of the covering shelf 100 may be unfolded on a plane.

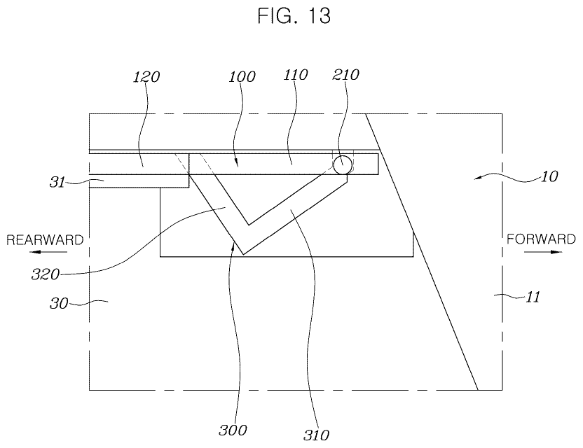

FIG. 13 illustrates a situation before the reclining operation of the seatback 11 of the rear seat 10 is performed. In this case, the front end portion 110 and the rear end portion 120 of the covering shelf 100 are unfolded in the forward/rearward direction, the front end portion 110 of the covering shelf 100 is fixed in position as the mounting rod 210 is caught by the catching projection 330 and seated, the rear end portion 120 of the covering shelf 100 is fixed in position as the rear end portion 120 is seated by being caught by the protrusion portion 31 protruding from the luggage side trim 30, and a rear surface of the seatback 11 is in contact with an end of the front end portion 110 of the covering shelf 100.

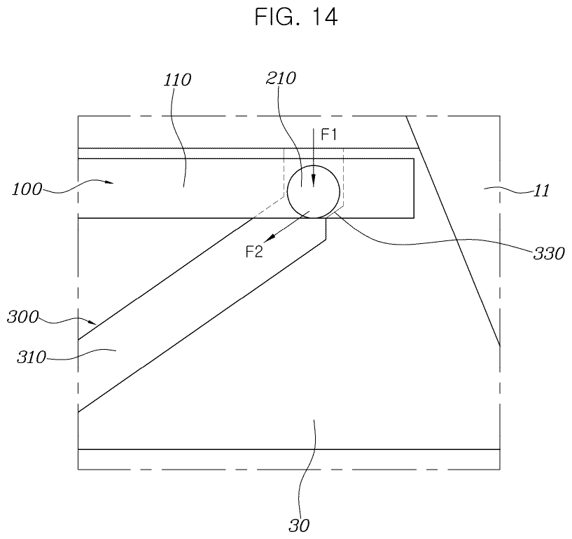

FIG. 14 is an enlarged view of a portion of FIG. 13 with the mounting rod 210 caught by the catching projection 330 and seated.

FIG. 15 illustrates a state in which the reclining operation of rotating rearward the seatback 11 of the rear seat 10 is completed.

In the state in FIG. 13, if the reclining operation of rotating rearward the seatback 11 of the rear seat 10 is performed, the front end portion 110 of the covering shelf 100 is rotated and folded downward relative to the rear end portion 120 of the covering shelf 100 by being pressed by the seatback 11.

If the front end portion 110 of the covering shelf 100 is rotated and folded downward, the mounting rod 210 passes over the catching projection 330 and then moves rearward and downward along the first groove 310 to the connection point between the first groove 310 and the second groove 320 by receiving downward and rearward forces as indicated by the arrows F1 and F2 in FIG. 14. As the mounting rod 210 moves rearward and downward along the first groove 310, the restoring spring 240 of the hinge unit 200 accumulates the spring force while being extended.

As illustrated in FIG. 15, in the state in which the mounting rod 210 is positioned at the connection point between the first groove 310 and the second groove 320, the front end portion 110 of the covering shelf 100 is supported by the seatback 11 of the rear seat 10 that has completed the reclining operation, such that the front end portion 110 of the covering shelf 100 may be kept in the state of being rotated downward.

Further, if the seatback 11 is rotated forward to reverse the reclining operation, the front of the front end portion 110 of the covering shelf 100 is rotated upward (e.g., from the folded position in FIG. 15) by the spring force of the restoring spring 240, and the mounting rod 210 may move forward and upward along the first groove 310.

Further, as illustrated in FIG. 13, if the upward rotation of the front end portion 110 of the covering shelf 100 is completed, the mounting rod 210 may be caught again by the catching projection 330 and seated, and the front end portion 110 of the covering shelf 100 and the rear end portion 120 of the covering shelf 100 may be unfolded on a plane.

As described herein, according to the covering shelf apparatus for a vehicle according to the present disclosure, the covering shelf 100 includes the front end portion 110 and rear end portion 120 folded and stacked in multiple layers, such that the covering shelf may be conveniently used and stored.

In addition, according to the covering shelf apparatus for a vehicle according to the present disclosure, the front end portion 110 of the covering shelf 100 may be rotated and folded relative to the rear end portion 120 of the covering shelf 100, such that the reclining operation of the rear seat 10 is allowable while the covering shelf 100 is deployed, thereby improving the ride quality and marketability.

The present disclosure is proposed to solve these problems and aims to provide a covering shelf apparatus for a vehicle, the covering shelf apparatus being capable of coping with a reclining operation of a rear seat and particularly being used and stored in a collapsible manner, thereby assisting in improving ride quality of a passenger and improving marketability.

In order to achieve the above-mentioned object, the present disclosure provides a covering shelf apparatus for a vehicle, the covering shelf apparatus including: a covering shelf structured to be folded and stacked in multiple layers; and hinge units coupled to two opposite left and right sides of a front end portion of the covering shelf and having mounting rods configured to move forward or rearward, in which the front end portion of the covering shelf to which the hinge units are coupled allows a reclining operation of a seatback of a rear seat while being rotated and folded downward by being pressed by the seatback when the reclining operation of rotating the seatback rearward is performed.

The covering shelf may include: the front end portion to which the hinge units are coupled; and a rear end portion extending rearward from the front end portion and having a longer length in a forward/rearward direction than the front end portion, and the front end portion and the rear end portion may be structured to be rotated and folded relative to each other.

The rear end portion may be structured to be folded and stacked at least in three or more layers.

The covering shelf may be accommodated and stored in an accommodation space of a luggage board in a state in which the covering shelf is folded and stacked in multiple layers.

The covering shelf apparatus may further include: a guide groove formed in a luggage side trim so that the mounting rod of the hinge unit is inserted into the guide groove, the guide groove being configured to guide a movement of the mounting rod when the front end portion of the covering shelf, to which the hinge unit is coupled, is rotated and folded downward or rotated and unfolded upward by the reclining operation of the rear seat.

The front end portion of the covering shelf may be installed as the mounting rod of the hinge unit is inserted into the guide groove of the luggage side trim, and the rear end portion of the covering shelf may be installed as two opposite left and right sides thereof are seated on protrusion portions protruding from the luggage side trim.

The hinge units further may include hinge housings fixedly coupled to two opposite left and right sides of the front end portion of the covering shelf and having slit holes extending in the forward/rearward direction, and the mounting rod may penetrate the slit hole, such that one end portion of the mounting rod is positioned in the hinge housing, and the other end portion of the mounting rod protrudes to the outside of the hinge housing and is inserted into the guide groove so that the mounting rod is movable forward or rearward along the slit hole.

The hinge unit may further include a restoring spring having two opposite ends coupled to the mounting rod and the hinge housing, the restoring spring may be extended when the mounting rod moves rearward, and the restoring spring may move the mounting rod forward and return the mounting rod by using a spring force.

A guide protrusion may be formed on the hinge housing and extend in a movement direction of the mounting rod, an insertion groove may be formed in the mounting rod so that the guide protrusion is inserted into the insertion groove, and a forward/rearward movement of the mounting rod may be guided by the guide protrusion and the insertion groove.

The guide groove may include: a first groove inclined rearward and downward from a front side and configured to guide the movement of the mounting rod when the front end portion of the covering shelf is rotated and folded downward or rotated and unfolded upward by the reclining operation of the rear seat; and a second groove connected to a rear end portion of the first groove and inclined rearward and upward, and two opposite sides of the front end portion of the covering shelf may be positioned in the second grooves when the front end portion of the covering shelf is rotated and folded downward and the mounting rod is positioned at a connection point between the first groove and the second groove.

A front end portion of the first groove may be opened upward, such that the mounting rod is inserted into the first groove, or the mounting rod is separated from the first groove.

A catching projection may be provided at the front end portion of the first groove and protrude toward the inside of the first groove, and when the mounting rod is caught by the catching projection and seated, the front end portion of the covering shelf and the rear end portion of the covering shelf may be unfolded on a plane.

The front end portion of the covering shelf may be rotated and folded downward relative to a rear end portion of the covering shelf by being pressed by the seatback when the reclining operation of rotating rearward the seatback of the rear seat is performed, and the mounting rod, which is caught by the catching projection when the front end portion of the covering shelf is rotated and folded downward, may pass over the catching projection and moves rearward and downward along the first groove to the connection point between the first groove and the second groove, and the restoring spring may accumulate a spring force while being extended when the mounting rod moves rearward and downward along the first groove.

The front end portion of the covering shelf may be supported by a seatback, which has completed the reclining operation, and kept in a state of being rotated downward in a state in which the mounting rod is positioned at the connection point between the first groove and the second groove, the front end portion of the covering shelf may be rotated upward by the spring force of the restoring spring and the mounting rod may move forward and upward along the first groove when the seatback rotates forward and returns, and the mounting rod may be caught by the catching projection and seated and the front end portion of the covering shelf and the rear end portion of the covering shelf may be unfolded on a plane when the upward rotation of the front end portion of the covering shelf is completed.

According to the covering shelf apparatus for a vehicle according to the present disclosure, the covering shelf includes the front end portion and rear end portion folded and stacked in multiple layers, such that the covering shelf is conveniently used and stored.

In addition, according to the covering shelf apparatus for a vehicle according to the present disclosure, the front end portion of the covering shelf may be rotated and folded relative to the rear end portion of the covering shelf, such that the reclining operation of the rear seat is allowable, thereby improving the ride quality and marketability.

The effects obtained by the present disclosure are not limited to the aforementioned effects, and other effects, which are not mentioned above, will be clearly understood by those skilled in the art from the following description.

While the specific examples of the present disclosure have been illustrated and described, it will be obvious to those skilled in the art that the present disclosure may be variously modified and changed without departing from the technical spirit of the present disclosure defined in the appended claims.

What is claimed is:

1. A covering shelf apparatus for a vehicle, the covering shelf apparatus comprising:
a covering shelf configured to be folded and stacked in multiple layers; and
a pair of hinges each coupled to one of two opposite sides of a front end portion of the covering shelf, wherein each of mounting rods of the pair or hinges is configured to move forward or rearward relative to a corresponding hinge of the pair of hinges,
wherein the front end portion is configured to be rotated and folded downward based on the front end portion being pressed by a seatback of a rear seat of the vehicle being reclined.

2. The covering shelf apparatus of claim 1, wherein the covering shelf comprises:
the front end portion; and
a rear end portion extending rearward from the front end portion and having a longer length in a forward/rearward direction than the front end portion, wherein the front end portion and the rear end portion are configured to be rotated and folded relative to each other.

3. The covering shelf apparatus of claim 2, wherein the rear end portion is configured to be folded and stacked at least in three layers.

4. The covering shelf apparatus of claim 1, wherein the covering shelf is configured to be removed from a luggage side trim of the vehicle and folded and stacked in multiple layers so as to be accommodated and stored in an accommodation space of a luggage board of the vehicle.

5. The covering shelf apparatus of claim 2, wherein:
each of the mounting rods of the pair of hinges is configured to be inserted in a corresponding guide groove of a pair of guide grooves formed in a corresponding luggage side trim of luggage side trims of the vehicle, and
the guide grooves are configured to guide a movement of the mounting rods when the front end portion of the covering shelf is rotated and folded downward by reclining of the rear seat or rotated and unfolded upward by reversal of the reclining of the rear seat.

6. The covering shelf apparatus of claim 5, wherein the front end portion of the covering shelf is configured to be installed by insertion of the mounting rods into the guide grooves, and
wherein the rear end portion of the covering shelf is configured to be installed by seating on protrusions from the luggage side trims.

7. The covering shelf apparatus of claim 5, wherein each hinge of the pair of hinges comprises a hinge housing fixedly coupled to a corresponding side of the two opposite sides of the front end portion of the covering shelf,
wherein each hinge housing, of the hinge housings, forms a slit hole extending in a longitudinal direction of the hinge housing, and
wherein each of the mounting rods penetrates a corresponding slit hole of the slit holes, such that the mounting rods are movable along the slit holes.

8. The covering shelf apparatus of claim 7, wherein each hinge of the pair of hinges further comprises a restoring spring coupling one of the mounting rods to one of the hinge housings, such that the restoring spring extends and generates a restoring spring force based on the one of the mounting rods moving rearward.

9. The covering shelf apparatus of claim 7, wherein each of the hinge housings comprises a guide protrusion that protrudes into the hinge housing and extends in the longitudinal direction,
wherein the mounting rods each form an insertion groove that is configured to accommodate one of the guide protrusions inserted into the insertion groove, and
wherein movement of the mounting rods is guided by the guide protrusions and the insertion grooves.

10. The covering shelf apparatus of claim 8, wherein each of the guide grooves comprise:
a first groove inclined rearward and downward and configured to guide movement of one of the mounting rods inserted in the first groove when the front end portion of the covering shelf is rotated and folded downward or rotated and unfolded upward; and
a second groove connected to a rear end portion of the first groove and inclined rearward and upward, and
wherein, when the front end portion of the covering shelf is rotated and folded downward, the two opposite sides of the front end portion of the covering shelf are positioned in the second grooves and each of the mounting rods is positioned at a connection point between a corresponding first groove of the first grooves and a corresponding second groove of the second grooves.

11. The covering shelf apparatus of claim 10, wherein each of the mounting rods is configured to be inserted into, or removed from, the corresponding first groove via a front end portion of the corresponding first groove opened upward.

12. The covering shelf apparatus of claim 11, wherein a catching projection is provided at the front end portion of the corresponding first groove and protrudes toward an inside of the corresponding first groove, and
wherein, when the mounting rods are caught by the catching projections of the first grooves and seated, the front end portion of the covering shelf and the rear end portion of the covering shelf are unfolded.

13. The covering shelf apparatus of claim 12, wherein the front end portion of the covering shelf is configured to be rotated and folded downward relative to the rear end portion of the covering shelf based on the front end portion of the covering shelf being pressed by the seatback of the rear seat during the reclining of the rear seat,
wherein the mounting rods are configured to, based on the front end portion of the covering shelf being pressed by the seatback, pass over the catching projections and move rearward and downward along the first grooves to the connection points, and
wherein the restoring springs generate a spring force while being extended by the mounting rods moving rearward and downward along the first grooves.

14. The covering shelf apparatus of claim 13, wherein the front end portion of the covering shelf is configured to be maintained, by the reclined seatback, rotated downward with the mounting rods positioned at the connection points,
wherein the front end portion of the covering shelf is configured to be, based on reversal of the reclining of the seatback, rotated upward by the spring force of the restoring springs such that the mounting rods move forward and upward along the first grooves, and
wherein, based on completion of the upward rotation of the front end portion of the covering shelf, the mounting rods are configured to be caught by the catching projections and seated and the front end portion of the covering shelf and the rear end portion of the covering shelf are configured to be unfolded.

15. A vehicle comprising:
a rear seat configured to recline backward;
a luggage room, rear to the rear seat, comprising:
a first luggage side trim forming a first guide groove; and
a second luggage side trim forming a second guide groove; and
a covering shelf comprising:
a first hinge coupled to a first side of a front end portion of the covering shelf;
a second hinge coupled to a second side of the front end portion of the covering shelf;
a first mounting rod configured to move forward or rearward relative to the first hinge; and
a second mounting rod configured to move forward or rearward relative to the second hinge,
wherein the first and second guide grooves are configured to guide movements of the first and second mounting rods based on reclining of the rear seat or reversal of reclining of the rear seat.

16. The vehicle of claim 15, wherein the first guide groove comprises:
a first groove portion inclined rearward and downward and configured to guide movement of the first mounting rod inserted in the first groove portion based on the front end portion of the covering shelf being rotated and folded downward or rotated and unfolded upward; and
a second groove portion connected to a rear end portion of the first groove portion and inclined rearward and upward, and
wherein, when the front end portion of the covering shelf is rotated and folded downward, the first side of the front end portion of the covering shelf is positioned in the second groove portion and the first mounting rod is positioned at a connection point between the first groove portion and the second groove portion.

17. The vehicle of claim 15, wherein the luggage room further comprises a luggage board comprising an accommodation space, wherein the covering shelf is configured to be folded and staked in multiple layers to fit in the accommodation space.

18. The vehicle of claim 15, wherein the covering shelf comprises:
the front end portion; and
a rear end portion extending rearward from the front end portion, wherein the front end portion and the rear end portion are configured to be rotated and folded relative to each other.

19. The vehicle of claim 15, wherein the first hinge comprises a hinge housing fixedly coupled to the first side of the front end portion of the covering shelf,
wherein a slit hole is formed in the hinge housing and extends in a longitudinal direction of the hinge housing, and
wherein the first mounting rod penetrates the slit hole, such that a first end of the first mounting rod is positioned in the hinge housing, and a second end of the first mounting rod protrudes from the hinge housing and is configured to be inserted into the first guide groove so that the first mounting rod is movable along the slit hole.

20. The vehicle of claim 19, wherein the first hinge further comprises a restoring spring coupling the first mounting rod to the hinge housing, such that the restoring spring extends and generates a restoring spring force based on the first mounting rod moving rearward.
